(19) United States
(12) Patent Application Publication
(10) Pub. No.: US 2026/0287109 A1
(43) Pub. Date: Sep. 24, 2026

(54) CURB EXTENSION WITH REDUCER AND ENLARGER FOR ROOF MOUNTED EQUIPMENT

(71) Applicants: Henry Gembala, Delray Beach, FL (US); David Gembala, Delray Beach, FL (US)

(72) Inventors: Henry Gembala, Delray Beach, FL (US); David Gembala, Delray Beach, FL (US)

(21) Appl. No.: 19/086,818

(22) Filed: Mar. 21, 2025

(51) Int. Cl. F16M 5/00

(52) U.S. Cl. CPC F16M 5/00

(57) ABSTRACT

A roof curb extension includes an integral one-piece body having a lower end portion with a flashing for attachment to an existing curb and an upper portion defining a new curb and a central portion structured and configured for enlarging or reducing the size of the new curb for matching roof equipment to the new curb without disturbing the integrity of the existing roof.

### BACKGROUND OF THE INVENTION

### Field of the Invention

The present invention relates to roof curbs for mounting rooftop equipment and, more particularly, to a roof curb extension for joining rooftop equipment to an existing base curb.

### Description of the Related Art

Roof curbs are used to support equipment mounted upon the flat roofs of industrial or commercial buildings. More particularly, the curb supports equipment, such as A/C units, gravity vents, exhaust fans and gooseneck ventilation members at a position that is spaced above the level of the roof to avoid infiltration and possible damage by rainwater or other liquid that may accumulate on the rooftop. Typical roof curb structures are fabricated from sheet metal, such as galvanized steel, which is then formed to include a base flange and upwardly extending wall members in a box-like structure that is sized to correspond to a particular size of equipment that is to be mounted on the curb.

However, problems can arise when the size of the rooftop equipment is unknown at the time of the roof construction. If the equipment is larger or smaller than originally anticipated, the curb platform must be modified at the site and may subsequently result in leakage problems. A more common problem encountered is when equipment needs to be replaced and the size of the new equipment is different from the old equipment. In either case, the curb platform has to be cut bigger or the platform and/or curb must be torn out completely and replaced with a new curb. Of course, this is problematic as it is undesirable to cut through the roof after the roof has been properly installed because this can damage the structural integrity of the roof.

Accordingly, there remains a need for a roof curb extension that is sized for attachment to an existing roof curb, and which allows for enlargement or reduction of the roof curb size to accommodate new rooftop equipment without disturbing the integrity of the underlying roof structure.

The purpose of the roof curb extension of the present invention is to avoid situations where the equipment size cannot be determined before the roof is constructed, or when existing rooftop equipment needs to be replaced with new equipment that is of a different size. In addition, in the event a roof needs to be replaced due to current building codes, the new roof will need tapered insulation and/or lightweight concrete to achieve the ¼ inch per foot slope and required R-value. This results in the need for installation of a higher roof curb to accommodate the height of the new equipment. However, by using the roof curb extension of the present invention, the existing roof curb can remain because the roof curb extension will accommodate the height of the new insulation and/or lightweight concrete. Use of the roof curb extension of the present invention in any of the several situations (i.e., replacement of roof top equipment, new construction where equipment size is unknown, and roof replacement to meet current building codes) will save money and time.

### SUMMARY OF THE INVENTION

A roof curb extension according to the present invention includes an integral one-piece body having a lower end portion with a flashing for attachment to an existing roof curb and an upper portion defining a new curb. The roof curb extension further includes a central portion structured and configured for enlarging or reducing the size of the new curb for matching roof equipment to the new curb without disturbing the integrity of the existing roof.

In at least one embodiment, the roof curb extension has four sides, with each side having the flashing, one wall of the new curb and one wall of the central portion extending between the flashing and the one wall of the new curb. In one embodiment, wherein the central zone is structured for reducing the size of the new curb, each wall of the central portion, on each side of the roof curb extension, is angled inwardly relative to the lower end flashing and existing curb so that the transverse length of each wall of the new curb is less than the transverse length of the wall on each side of the existing curb, thereby reducing the overall size of the new curb relative to the existing curb.

In another embodiment of the invention, the walls of the central portion on each side of the roof curb extension are angled outwardly relative to the lower end flashing and side walls of the existing curb, so that the transverse length of each wall on the sides of the new curb is greater than the length of the corresponding side wall on the existing roof curb so that the overall size and dimensions of the new curb is greater than the existing curb. Thus, the roof curb extension of the present invention allows for enlargement or reduction of the new roof curb size to accommodate new rooftop equipment without removing and replacing the existing roof curb, and more importantly, without disturbing the integrity of the underlying roof structure. Use of the roof curb extension of the present invention further saves money and time, whether used for new equipment, new roof installation, or roof and/or equipment replacement.

### BRIEF DESCRIPTION OF THE DRAWINGS

For a fuller understanding of the nature of the present invention, reference should be had to the following detailed description taken in connection with the accompanying drawings in which:

FIG. 1 is a top, side perspective view showing one embodiment of the curb extension of the present invention secured to an existing roof curb which includes a central zone for reducing the size of a new curb on the curb extension;

FIG. 2 is an isolated view of one side of the existing roof curb and roof curb extension attached thereto illustrating the profile of a side of the roof curb extension, wherein the central portion is angled inwardly relative to the side wall of the existing roof curb to effectively reduce the overall size and dimension of the new roof curb;

FIG. 3 is a top, side perspective view showing the curb extension member of the present invention secured to an existing roof curb, and wherein the curb extension includes a central portion for enlarging the size of the new curb of the curb extension; and

FIG. 4 is an isolated view of one side of the existing roof curb and roof curb extension attached thereto illustrating the profile of a side of the roof curb extension, wherein the central portion is angled outwardly relative to the corresponding side wall of the existing roof curb to effectively enlarge the overall size and dimension of the new roof curb.

Like reference numerals refer to like parts throughout the several views of the drawings.

### DETAILED DESCRIPTION OF THE PREFERRED EMBODIMENTS

Referring to the several views of the drawings, several embodiments of the roof curb extension of the present invention are shown. In each drawing figure, the several embodiments of the roof curb extension are generally indicated as 10.

The roof curb extension 10 includes an integral one-piece body 12 having a lower end portion 14 with a flashing 16 for attachment to an existing roof curb 100, and an upper portion 18 defining a new curb. The roof curb extension 10 further includes a central portion 20 structured and configured for either enlarging or reducing the size of the new curb 18 for matching roof equipment to the new curb without the need to remove the existing curb 100 and further, without the need to disturb the integrity of the existing roof.

In at least one embodiment, the roof curb extension 10 is formed from sixteen-gauge galvanized metal, such as galvanized steel, and is cut, bent and welded in areas to form the integral one-piece body 12. The several embodiments of the roof curb extension 10 shown in the drawing figures each have four sides (A, B, C and D), with each side being correspondingly aligned with a side of the existing roof curb 100. In most situations, the existing roof curb 100 will have four sides, which may be either square or rectangular in shape, so that all sides are either equal in transverse length or opposite sides are equal in length (i.e., to form a rectangular curb). It should be noted, however, that the roof curb extension 10 may be formed and configured to have fewer or greater than four sides to accommodate the particular situation, and more importantly, to allow for proper fitted attachment to an existing roof curb 100.

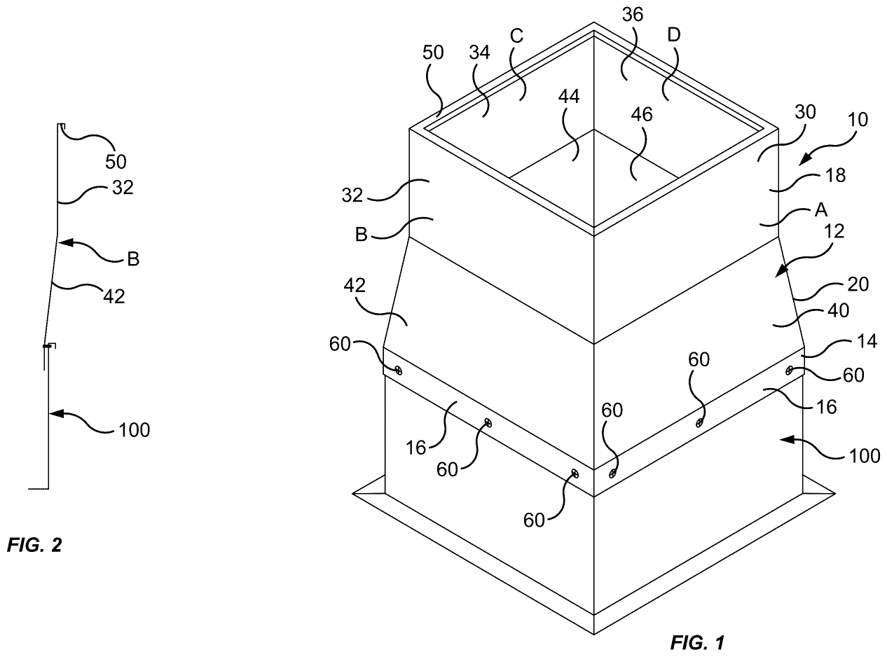

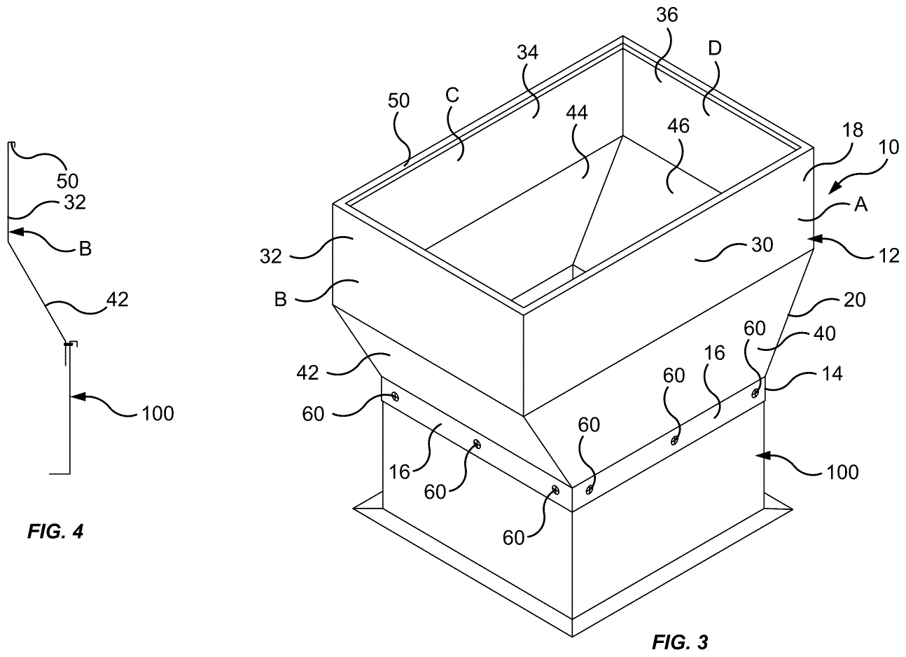

Each side (A, B, C and D) of the roof curb extension 10 includes a length of the lower flashing 16 on the lower end portion that is sized for attachment to the corresponding side wall of the existing roof curb, as seen in FIGS. 1 and 3. Each side of the roof curb extension further includes one wall (30, 32, 34, 36) of the new curb 18, as well as one wall (40, 42, 44, 46) of the central portion 20 that extends from the lower flashing 16 to the one wall (30, 32, 34, 36) of the new curb 18. Thus, referring to FIG. 1, the roof curb extension 10 includes the four sides (A, B, C and D) including four walls of the new curb, and four walls of the central portion. Similarly, referring to FIG. 4, the roof curb extension 10 includes four sides (A, B, C and D), with each side having four walls of the new curb and four corresponding walls of the central portion.

The embodiment shown in FIGS. 1 and 2 is specifically structured and configured for reducing the size of the new curb 18 on the roof curb extension 10. As can be seen in FIG. 1, the overall size and dimension of the new roof curb 18 is smaller than the existing curb 100. This is achieved by angling the walls (40, 42, 44 and 46) of the central portion 20 inwardly relative to the lower end flashing 16 and existing roof curb 100. As seen in FIG. 2, each wall of the central portion 20 is angled inwardly relative to the corresponding side wall of the existing curb. In this particular example, each wall of the central portion 20 is angled inwardly approximately 7 degrees from vertical. Thus, each wall of the new curb 18 is positioned inwardly relative to the corresponding wall of the existing curb 100 below the new curb.

Referring to FIGS. 3 and 4, the roof curb extension 10 is specifically structured and configured for enlarging the size of the new curb 18 relative to the existing curb 100. This is accomplished by angling each wall of the central portion 20 outwardly relative to the lower end flashing 16 and corresponding side walls of the existing curb 100. As seen in FIG. 3, the overall size and dimension of the new curb 18 is larger than the size of the existing curb 100. Referring to FIG. 4, it is seen that each wall (40, 42, 44 and 46) of the central portion 20 of the roof curb extension 10 is angled outwardly relative to the corresponding wall of the existing curb 100, on each side. In this example, each wall of the central portion 20 is angled outwardly 30 degrees from vertical. Naturally, this positions the side walls (30, 32, 34 and 36) of the new curb 18 outwardly relative to the side walls of the existing curb 100 so that the transverse length of each side wall (30, 32, 34 and 36) of the new curb 18 is greater than the transverse length of the correspondingly positioned side wall of the existing curb 100, on each side.

In each of the embodiments, the top of the new curb 18 is provided with an inwardly directing lip 50 extending inwardly approximately 1.5 inches and then downwardly approximately 1 inch. The inwardly directing lips 50 on each side are then welded at the corners.

Further, in each embodiment, the flashing 16 on the lower end portion 14 of the roof curb extension 10 is attached to the upper portion of the walls of the existing roof curb 100 with screw fasteners 60. In a preferred embodiment, the flashing 16 on the lower end portion on each side of the roof curb extension is secured to the side walls of the existing curb with the use of Phillips or square drive pancake head self-drilling zinc plated steel screws #10×1 inch spaced 6 inches apart on center.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A roof curb extension for attachment to an existing roof curb, the roof curb extension comprising:
a lower end portion, an upper portion and a central portion extending between the lower end portion and the upper portion;
the lower portion including a flashing for attachment to the existing roof curb;
the central portion including side walls extending upwardly from the lower end portion and angled away from vertical from the lower end portion to the upper portion; and
the upper portion defining a new roof curb that is of a different size relative to the existing roof curb, and the new roof curb being specifically sized, dimensioned and configured for supported attachment of a particular unit of rooftop equipment thereon.

2. The roof curb extension as recited in claim 1 wherein the roof curb extension is formed as an integral one-piece monolithic body.

3. The roof curb extension as recited in claim 2 wherein the side walls of the central portion are angled inwardly relative to the existing roof curb to provide a reduced size of the new curb relative to the existing roof curb.

4. The roof curb extension as recited in claim 2 wherein the side walls of the central portion are angled outwardly relative to the existing roof curb to provide an enlarged size of the new curb relative to the existing roof curb.

5. The roof curb extension as recited in claim 2 wherein a top end of the upper portion includes a lip extending inwardly and downwardly, providing a flat horizontal ledge around a periphery of the top end of the upper portion.
